(19) United States
(12) Patent Application Publication
(10) Pub. No.: US 2010/0000142 A1
(43) Pub. Date: Jan. 7, 2010

(54) Submersible buoyant bait dispenser

(76) Inventors: Robert Thompson, Prior Lake, MN (US); Tim Kloss, Mankato, MN (US)

Correspondence Address: Law Offices of Douglas L. Tschida, 93 Little Canada Road West, Suite 202, ST. PAUL, MN, 55117, US

(21) Appl. No.: 12/459,681

(22) Filed: Jul. 6, 2009

Related U.S. Application Data
(60) Provisional application No. 61/134,164, filed on Jul. 7, 2008.

(51) Int. Cl. A01K 97/05; A01K 97/01

(52) U.S. Cl. 43/4.5; 43/55

(57) ABSTRACT

A buoyant live bait container constructed to contain a quantity of live bait beneath the surface of a body of water via a tether line coupled to ballast anchor and/or nesting flotation collar. A twist-lock cover having a buoyant liner, flow ports and/or carry handle interlocks with a porous storage housing. A positive buoyancy collar can be fitted to the housing. Holes, ported appendages or a cross piece displaced from a concave housing bottom wall can support a tether line coupled to a ballasted anchor. The housing can also provide a longitudinal sidewall flotation member.

### RELATED APPLICATION DATA

This is a non-provisional application of provisional application Ser. No. 61/134,164 filed Jul. 7, 2008.

### BACKGROUND OF THE INVENTION

The present invention relates to fishing bait containers and, in particular, to a buoyant, submersible container capable of being anchored and tethered to float beneath the surface of a body of water and maintain live bait for long periods.

Wide varieties of bait storage containers have been developed from a variety of materials in support of a variety of fishing applications. Most containers provide a ventilated or perforated storage cavity where the bait is contained. An access way or door is affixed to the container to permit storing and retrieving bait.

Some of such containers are designed to float and include a tether. Some containers are constructed of plastic and/or metal and include a positive buoyancy material fitted to the container. An associated cover can provide a carry handle and an access doors to the interior. A tether cord can be attached to the handle and the container can thereby be secured and/or towed by a boat during fishing while keeping bait (e.g. minnows, leeches, crayfish etc.) fresh and alive.

Fabric bait storage containers are also known. Porous, mesh bags are sometimes used to contain bait in a collapsible assembly that can also support one or more flotation members.

Live well containers are also used for storing relatively large fish before cleaning or preparing the stored fish for bait, chumming etc. Most of these assemblies provide a perforated, non-buoyant housing constructed to be fully or partially submersed. The container is typically anchored to a lake bottom in a shallow area to permit access to the container interior.

Some bait containers that have been developed for ice or “hard water” fishing are shown at U.S. Pat. Nos. 6,442,887; 5,419,073; 4,761,909; 2,877,595. These containers provide perforated, non-buoyant bait storage devices having handles to which tethers can be attached. The containers are designed to be suspended beneath the ice of a lake or body of water from a stationary surface structure. The bait is accessed by pulling the container through an ice hole through which the tether is trained. Although the foregoing devices can store bait for relatively long periods, difficulties can arise due to re-freezing of the access hole and when attempting to open the hole through which the tether and container are suspended. The principle problem is that of re-opening the hole with an auger or chisel without damaging the tether or container.

A tethered, submersible chumming container with a pivoting door is shown at U.S. Pat. No. 6,138,400.

The present bait container was developed to overcome the problems when ice fishing of opening a tether support hole without damaging the tether or bait container. Several bait containers are disclosed that include various improvements and modifications to provide a container that floats freely and can be tethered to an anchor or a variety of surface structures. The disclosed assemblies particularly float freely beneath the ice and are anchored within easy each reach of a hole. The access hole can be re-opened repeatedly without concern for cutting a tether line. New holes can also be cut in the adjacent vicinity to capture the container or anchor tether with an extension tool.

### SUMMARY OF THE INVENTION

It is a primary object of the invention to provide a buoyant bait storage container that can be anchored beneath a body of ice, yet is easily accessed.

It is further object of the invention to provide a bait container having a porous storage cavity, a positive buoyancy member located to float the container and an anchoring assembly to restrain the container to a defined location.

It is further object of the invention to provide a bait container with a positive buoyancy member mounted at a cover and/or along longitudinal sidewalls and/or as a collar to the container housing.

It is further object of the invention to provide a bait container housing with anchoring mechanisms such as holes, ported appendages, and/or rods fitted to bottom walls and adapted to fasten to a tether line secured an anchor.

It is further object of the invention to provide a bait container that independently mounts to, tethers to and/or nests within a collapsible, buoyant flotation ring.

The foregoing objects, advantages and distinctions of the invention are obtained in several alternative assemblies shown at the attached figures. In one preferred assembly, a porous housing supports a threaded cover having a foam liner. Holes, ported appendages or a cross piece displaced from a concave bottom wall supports a tether line that attaches to a weighted anchor that rests on the bottom of the body of water. Improvements and modifications include different covers and housings with ported openings, an annular floatation collar, a longitudinal sidewall flotation member twist-lock fasteners or a flotation anchor.

Still other objects, advantages, distinctions, constructions and combinations of individual features of the invention will become more apparent from the following description with respect to the appended drawings. Similar components and assemblies are referred to in the various drawings with similar alphanumeric reference characters. The description to each combination should therefore not be literally construed in limitation of the invention. Rather, the invention should be interpreted within the broad scope of the further appended claims.

### BRIEF DESCRIPTION OF THE DRAWINGS

The following figures disclose presently preferred constructions of the invention. Similar components and assemblies are referred to in the various drawings with similar alphanumeric reference characters and callouts.

FIG. 1 shows a drawing depicting the bait container in partial cutaway to expose a buoyant cover liner.

FIG. 2 shows a perspective drawing of the porous bait container in partial cutaway to expose a buoyant cover liner.

FIG. 3 shows an enlarged detailed partial section view to the twist-type cover/container fasteners.

FIG. 4 shows a view to a buoyant bait container having a longitudinal sidewall section fitted with or constructed from a buoyant flotation material and providing other tether attachments that can be adapted to any of the disclosed bait containers.

### DESCRIPTION OF THE PREFERRED EMBODIMENT

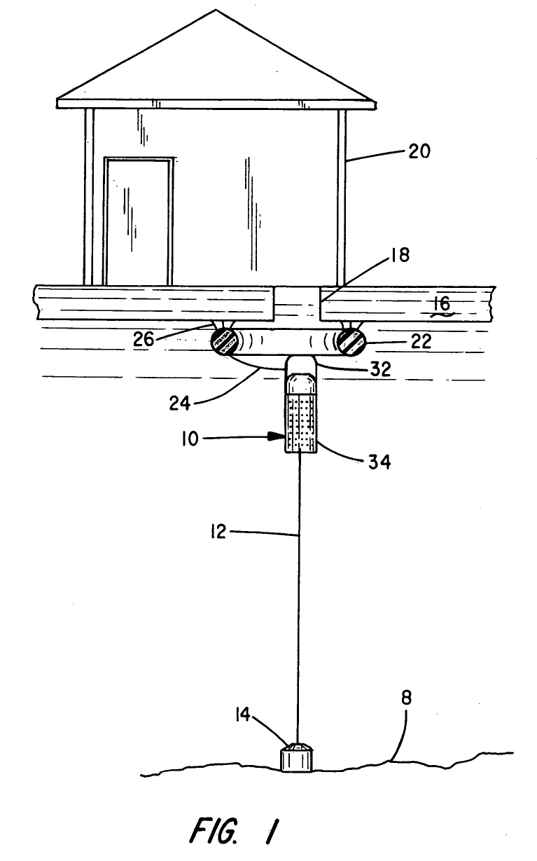

Referring to FIG. 1, a schematic drawing is shown to the improved live bait container 10 of the present invention restrained to the bed 8 of a body of water via a tether line 12 and ballast anchor 14. The container 10 is constructed to exhibit positive buoyancy and float beneath a layer of ice 16 having an access hole 18 and overlying fishing shelter 20. The container 10 can also be suspended beneath open ice without a shelter 20 provided some other means is available to mark the location of the access hole 18, for example, a flag, GPS coordinates etc.

The anchor 14 can comprise any device of suitable weight and shape to restrain the container 10 from drifting or moving with changing water currents. The tether line 12 preferably remains limp and flexible at the typical water temperatures. The tether line 12 is sufficiently durable to prevent separation from the anchor 14. The length of the tether line 12 can be varied as appropriate by knotting the line or using a bobbin device to limit the length of line to accommodate the water depth and a desired surface separation. The container is normally retrieved by catching the tether line 12 with a hooked device.

An alternative annular, positive buoyancy flotation collar 22 is also shown that can be aligned to the ice hole 18 and used to separately restrain the bait container 10 with a second tether line 24 in an aligned orientation to the ice hole 18. The collar 22 is constructed of a closed cell foam material and is configured to collapse and expand to circumscribe the periphery of the bottom edge of the ice hole 18. The collar 18 is held in place due to the upward positive buoyancy pressure of the foam material. Tentacles, spines, projections and other grip enhancing devices 26 can protrude from the collar 22 to enhance contact between the collar 22 and the ice 16 and prevent slippage due to water or ice movement.

The tether 24 locates the container 10 to the collar 22. The container 10 and collar 22 can also exhibit complementary mating surface shapes such that the container 10 can nest with the bore space or other mating surface or accessory piece supported to the collar 22 and configured to interconnect with the container 10. In either instance, the container 10 is restrained and positioned in non-interfering relation to the hole 18 should it be necessary to periodically re-open the ice hole 18. The ice hole 18 can now be opened without concern for damaging the container 10 or cutting the tether line 12.

The anchor 14 and/or anchor collar 22 can be used separately or in combination to restrain the container 10 at a fixed location relative to the ice hole 18. The container 10 can thereby be repeatedly accessed to either fill or collect live bait stored in the container 10. The live bait is also stored without concern for re-freezing of the hole 18 or migration of the container 10.

The container 10 finds particular advantage when ice fishing however the container 10 can be used to store live bait in open water. During “open water” summer condition a second tether line 24 can alternatively secure the container 10 to a variety of surface structure (e.g. dock, boat, collar 22, float tree etc.) alone or in combination with the tether line 12 and anchor 14.

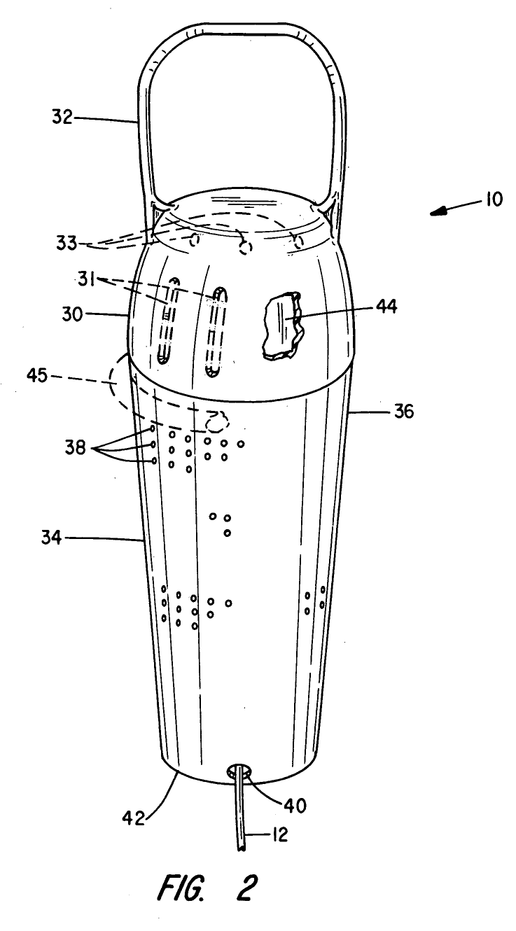

FIG. 2 depicts particular details to the construction of the container 10. From FIG. 2, the container 10 is constructed of a suitable plastic material that is formed to provide a twist-off cover 30 having a handle 32. Longitudinal slots 31 or apertures 33 (shown in dashed line) or other shaped orifices can be formed through the cover 30 to facilitate water flow in the event the container is towed during open water fishing.

The cover 30 is secured to a depending cylindrical storage housing 34. The housing sidewalls 36 are perforated with numerous holes or apertures 38. The density and size of the holes 38 and the size and shape of the housing 34 can be varied as desired in relation to the typical stored bait to ensure adequate space and liquid flow. One or more additional holes 40 are provided adjacent a bottom peripheral edge 42 as a tie-off point for the tether line 12. The shape of the handle 32 can also be adjusted to facilitate carrying and/or attachment to the tether lines 10 and/or 24 or which can be attached as mentioned above to the floatation collar 22, boat etc.

A liner 44 shown in partial section is fitted beneath the cover 30 and is formed from a positive buoyancy material. The liner 44 is constructed to mount securely beneath the cover 30 to provide positive buoyancy to the container 10 and cause the container 10 to float. The liner 44 is bonded to the cover 30 with suitable adhesives or the like. The cover 30 can alternatively be completely constructed of a positive buoyancy material. A buoyant, annular collar or ring 45 (shown in dashed line) might alternatively be secured around the housing 34 or be used in combination with the liner 44 at an appropriate location (e.g. adjacent the cover/container joint or tether holes 40) to facilitate flotation relative to the anchor 14 or other manner of retention.

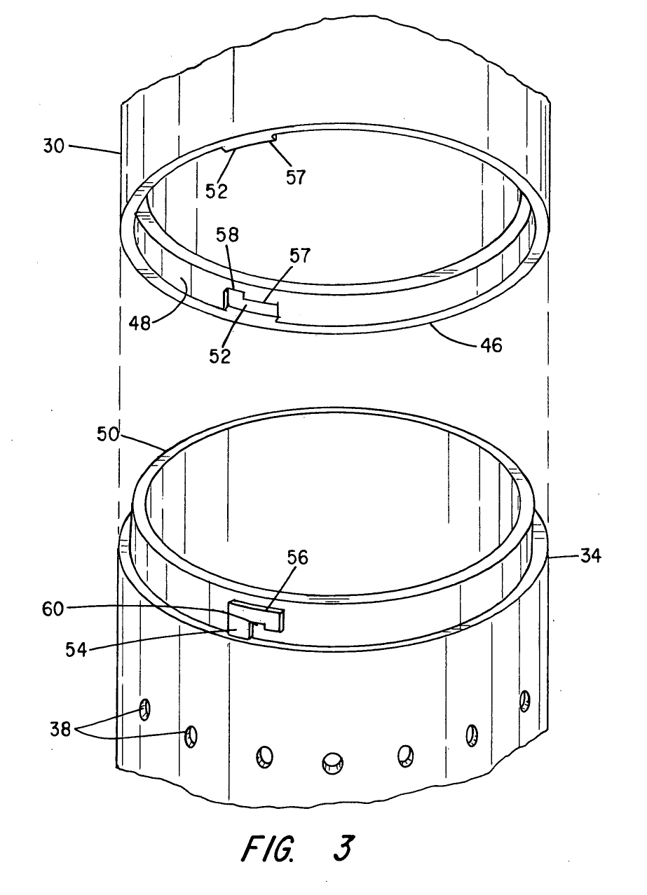

With attention to FIG. 3, the peripheral edge 46 of the cover 30 provides a recessed band 48 that concentrically mates with a raised edge 50 of the housing 34. Twist-type fasteners 52 (exemplary ones of which are shown) are arrayed about the band 48 and interlock with mating fastener pieces 54 (exemplary ones of which are shown) that are arrayed about the interlocking surface 50 of the housing 34.

The fasteners 52 twist-mount beneath a horizontal or circumferential extending flange piece 56 of the fasteners 54. A raised longitudinal stub 58 projects from a horizontal or circumferential extending flange piece 57 of the fastener 52 to interlock with a vertical or longitudinal groove 60 at the fastener piece 54. The overlapping flange pieces 56 and 57 securely fasten the cover 30 to the housing 34. The mating stub 58 and groove 60 provide redundancy and prevent detachment of the cover 30 from the housing 34 when the container 10 is towed. Live bait is accessed by depressing and rotating the cover 30 to the housing 34 to separate the cover 30 from the housing 34. A separate access door/opening could be included at the cover 30.

Although particular interlocking twist-type fastener pieces 52 and 54 are shown, other interlocking fasteners can be used to detachably secure the cover 30 to the housing 34. For example, a variety of other threaded, keyway and other mating fasteners may alternatively be used to secure the cover 30 to the housing 34. The cover 30 and housing 34 can be adapted to include interlocking threads or friction fit couplings can be provided. The latter might provide raised ridge pieces that mount in aligned depressions, for example, O-rings that mate with aligned grooves etc. Any included cover/housing fasteners should securely retain one to the other, yet facilitate repeated access to the bait without degrading the fastening, if a separate access panel is not provided at the cover. The fastening should also be tolerant to possible freezing and towing of the container 10.

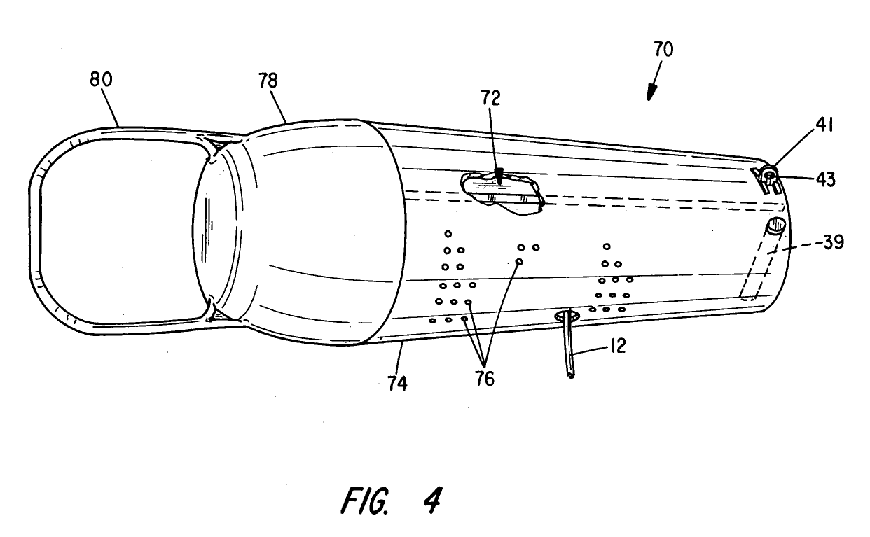

FIG. 4 depicts a container 70 that is constructed to float in a sideways or horizontal orientation. That is, a flotation member 72 is supported to or formed as part of the sidewall structure of a porous housing 74 having through vent holes 76. A cover 78 and handle 80 are fitted to an end of the housing 74. Tether lines 12 and/or 24 can be attached to either holes 40 provided at the container 70 or an alternative cross piece or bar 82 and/or appendages 84 having bores 86 that can be configured to the container 70 as tether attachment points. The bar 82 would normally be nested in a hollowed bottom space of the container 70.

While the invention is shown and described with respect to several presently preferred container assemblies and several considered improvements, modifications and/or alternatives thereto, still other container assemblies and arrangements may be suggested to those skilled in the art. It is to be appreciated therefore that the foregoing live bait container assembly and improvements can be arranged in different combinations. The improvements and modifications can also be used alone or with different containers. The foregoing description should therefore be construed to include all those embodiments within the spirit and scope of the following claims.

What is claimed is:

1. A bait container assembly comprising:
a) a cover having a recessed cavity and including a rigid handle projecting from the cover, a positive buoyancy member secured internal to a recessed cavity of the cover, and a band circumscribing a peripheral edge of said recessed cavity and supporting a plurality of raised first fastener pieces;
b) a housing including side and bottom walls defining a storage space for live bait, a plurality of apertures formed through the walls thereof to said storage space, a tether fastener, and a band circumscribing a peripheral edge of said recessed cavity and supporting a plurality of second fastener pieces that interlock with said first fastener pieces to secure said cover to said housing; and
c) a weighted ballast anchor and a tether line adapted to attach to said tether fastener such that said container assembly upon attachment to said anchor floats beneath the surface of a body of water with the cover submersed adjacent the surface for accessing the stored bait.

2. A bait container assembly as set forth in claim 1 wherein said tether fastener comprises a cross member that spans between sidewalls of said housing in an exposed cavity adjacent the bottom wall.

3. A bait container assembly as set forth in claim 1 including a buoyant collar member that mounts beneath a layer of surface ice and includes means for securing said container to said collar member.

4. A bait container assembly as set forth in claim 3 wherein said collar member comprises an annular, positively buoyant foam ring.

5. A bait container assembly as set forth in claim 3 wherein said collar member includes members which resiliently project to engage a submerged ice surface adjacent an ice hole and wherein said cover is shaped to nest within said collar member.

6. A bait container assembly as set forth in claim 1 wherein upon overlapping the bands of said of said cover and said housing and rotating the cover and/or housing at least one of said first and second fastener pieces is captured beneath the other.

7. A bait container assembly as set forth in claim 1 wherein one of said first and second fastener pieces includes a piece that circumferentially extends about a portion of the cover or housing band and includes a longitudinal groove and wherein the other of said first and second fastener pieces includes a piece that circumferentially extends about a portion of the mating cover or housing band and has a longitudinal projection located to interlock with said groove to prevent the release of said cover from said housing, unless said cover is depressed toward said housing and partially rotated at said housing to release the respective overlapping flanges and interlocking projection and groove.

8. A bait container assembly as set forth in claim 1 including an annular buoyant collar adapted to mount around said housing.

9. A bait container assembly comprising:
a) a cover having a recessed cavity and including a handle projecting from the cover and a band circumscribing a peripheral edge of said recessed cavity and supporting a plurality of first fastener pieces;
b) a housing including side and bottom walls defining a storage space for live bait, a plurality of apertures formed through the walls thereof to said storage space, a tether fastener, and a band circumscribing a peripheral edge of said recessed cavity and supporting a plurality of second fastener pieces that interlock with said first fastener pieces to secure said cover to said housing;
c) a positive buoyancy member secured the cover or housing; and
d) a weighted ballast anchor and a tether line adapted to attach to said tether fastener such that said container assembly upon attachment to said anchor floats beneath the surface of a body of water with the cover submersed adjacent the surface for accessing the stored bait.

10. A bait container assembly as set forth in claim 9 wherein said tether fastener comprises a hole in said housing.

11. A bait container assembly as set forth in claim 9 wherein one of said first and second fastener pieces includes a raised overlying flange piece that extends about a portion of the cover or housing band and a longitudinal groove and wherein the other of said first and second fastener pieces includes a raised underlying flange piece that circumferentially extends about a portion of the mating cover or housing band and includes a raised longitudinal projection that interlocks with said groove to prevent the release of said cover from said housing, unless said cover is depressed toward said housing and partially rotated at said housing to release the respective overlapping flanges and interlocking projection and groove.

12. A bait container assembly as set forth in claim 9 including a buoyant member adapted to mount beneath a layer of ice and having a surface shaped to mate with and contain said cover such that the buoyancy of said container assembly secures said container assembly to said collar member.

13. A bait container assembly as set forth in claim 9 wherein the positive buoyancy member is secured to horizontally suspend said container assembly relative to the water surface.

14. A method for storing live bait comprising:
a) inserting live bait into a storage space of a housing including side and bottom walls defining a storage space, a plurality of apertures formed through the walls thereof to said storage space, and a band circumscribing a peripheral edge of said recessed cavity and supporting a plurality of first fastener pieces;
b) mounting a cover including a handle projecting from the cover to the housing such that a band circumscribing a peripheral edge of the cover and supporting a plurality of second fastener pieces interlock with said first fastener pieces, and wherein a positive buoyancy member is secured to the assembled cover and housing;
c) attaching a tether line to the assembled cover and housing; and
d) attaching a weighted ballast anchor to said a tether line and submersing said anchor to the bottom of a body of water to suspend the assembled cover and housing beneath the surface of a body of water with the cover submersed adjacent the surface for accessing the stored bait.

15. A method as set forth in claim 14 including the step of mounting a buoyant collar beneath a layer of surface ice and positioning said cover to coaxially align with the collar.
